(19) United States
(12) Patent Application Publication
(10) Pub. No.: US 2006/0153349 A1
(43) Pub. Date: Jul. 13, 2006

(54) Method and system for transmission of vocal content by mms

(76) Inventors: Arnaud Brun, Boulogne Billancourt (FR); Clery Tonneau, Meudon (FR)

Correspondence Address: COHEN, PONTANI, LIEBERMAN & PAVANE, 551 FIFTH AVENUE, SUITE 1210, NEW YORK, NY, 10176, US

(21) Appl. No.: 10/563,937

(22) PCT Filed: Jul. 11, 2003
(86) PCT No.: PCT/FR03/02212

§ 371 Date: Jan. 9, 2006

(51) Int. Cl. H04M 1/64

(52) U.S. Cl. 379/88.22

(57) ABSTRACT

The invention relates to a method of making a sound content available that comprises a step of producing a sound content and sending it by means of a telephone terminal (10) and a step of receiving (20) and storing (32) said sound content with a view to subsequent consultation by a telephone terminal, the method being characterized in that it comprises a step of the telephone terminal (10) producing the sound content that precedes and is temporally separate from said step of the telephone terminal sending said sound content.

The field of the invention is that of telecommunications, and more particularly that of messaging systems using sound contents, in particular personalized voice contents.

Personalized voice contents are encountered in various forms in the field of telephony. They include in particular voice dispatches and voicemail greetings.

A voice dispatch is an audio message that is deposited in the voice mailbox of one or more parties having access to a voicemail system, for example a voice message proper recorded by the sender on top of a background sound.

A voicemail greeting is an audio message that a caller hears on calling a user who cannot be contacted (because the user's terminal is switched off or outside the network coverage area, the line is busy, calls are being transferred unconditionally to the voicemail service, the user declines to take the call, etc.).

In the field of voice dispatches, “indirect” message deposition now enables a user to record a voice message on any mobile or fixed terminal and deposit it in the voice mailbox of a correspondent. The user must call the voicemail system of the correspondent to use this service for which there is generally a charge (the cost is the same as that of a call to the correspondent).

Furthermore, using a voicemail system, a user can create private circulation lists, which enable the user to send the same voice message to a plurality of recipients, each of whom has a voice mailbox (a circulation list is thus a list of telephone numbers). Each of the user's circulation lists is generally identified by a list number (list 1, list 2, etc.).

This indirect message deposition service therefore enables the user to record and send a message containing the user's voice on its own.

Services for sending voice dispatches offer more functions, for example adding background music to a voice message, necessitating access from a mobile or fixed telephone to a voice server connected to the voicemail system in order to compose a voice dispatch. The user can then either select a prerecorded audio message or use functions available on the server to compose a voice dispatch personally.

There is generally a charge for using services for personalizing voice dispatches.

Turning now to voicemail greetings, existing systems generally enable a user to record a personalized voicemail greeting:

by calling the voicemail system from a mobile or fixed telephone: the user then records a voicemail greeting (incurring the cost of one call to the voice mailbox), or

from a PC via the WorldWide Web (if the operator provides this service): the user records a voicemail greeting using a microphone connected to the computer (this service is generally free of charge).

Thus in these situations the user can record only the user's own voice.

Services for personalizing voicemail greetings offering more functions necessitate access from a mobile or fixed telephone to a voice server connected to the voicemail system in order to compose a voicemail greeting. The user can then select a predefined voicemail greeting or use functions available on the server to compose a voicemail greeting personally.

There is generally a charge for using services for personalizing and sending voicemail greetings (generally a fixed connection charge plus the cost of a premium call).

The services mentioned above do not enable the user to compose a voice dispatch or a voicemail greeting in a truly personalized way and without worrying about the call duration.

Moreover, the above systems generally enable the user to personalize a voicemail greeting only by recording the user's own voice. For example, they do not provide for adding a signature sound at the beginning or end of the voicemail greeting to make the voicemail greeting more personal.

Nor do they enable background music to be added to a voicemail greeting to constitute a really personal voice content, for example.

The object of the invention is to provide means for producing a voice content and making it available that offer more extensive facilities for personalizing the content. The invention additionally aims to propose means of the above kind whereby the user is less likely to worry about the time taken to personalize the voice content.

The invention achieves the above object through a method of making a sound content available, the method comprising a step of producing a sound content and sending it by means of a telephone terminal and a step of receiving and storing said sound content with a view to subsequent consultation by a telephone terminal, the method being characterized in that it comprises a step of the telephone terminal producing the sound content that precedes and is temporally separate from said step of the telephone terminal sending said sound content.

The invention further proposes a telecommunications device for making available a sound content addressed to at least one telephone terminal holder, the device comprising a sound content receiver entity and a sound content storage entity that may be consulted by telephone, the device being characterized in that the receiving entity and the storage entity are adapted to read a message precomposed on a telephone terminal before it is sent thereby and to store a sound content included in that message in memory in a form that may be consulted.

Other features, objects and advantages of the invention will become apparent on reading the following detailed description, which is given with reference to the appended drawings, in which:

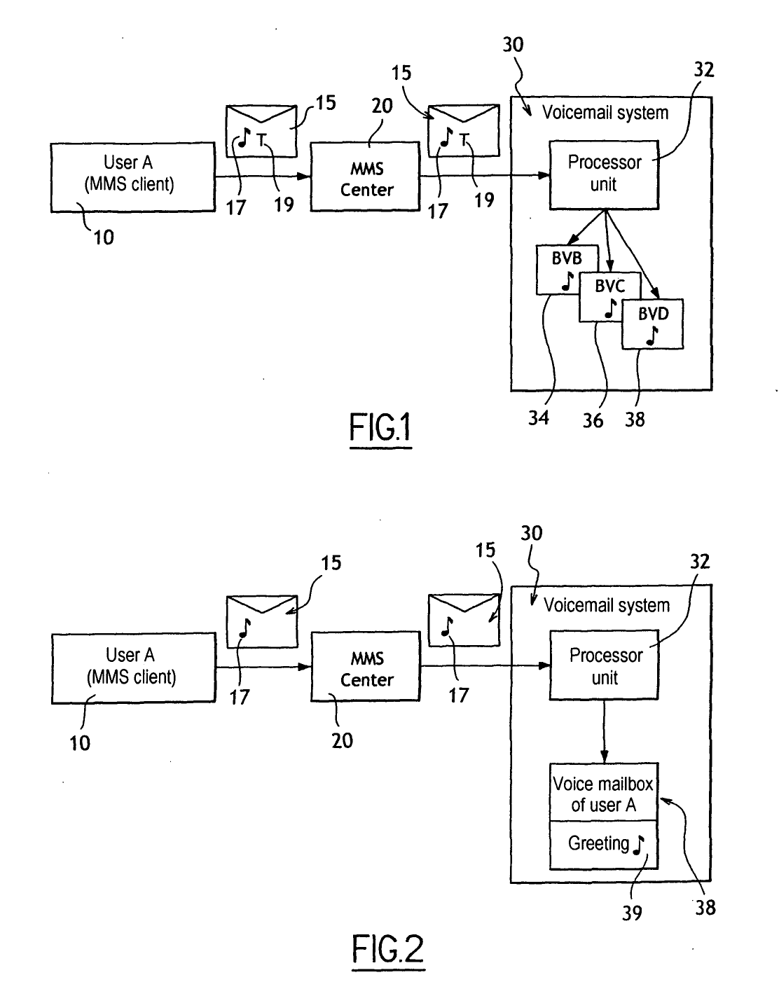

FIG. 1 represents an architecture enabling the implementation of a first variant of the invention, and

FIG. 2 represents an architecture enabling the implementation of a second variant of the invention.

Remember first that the multimedia messaging service (MMS) enables telephone users (mobile telephone users now and fixed telephone users in the future) to send and receive large multimedia messages (messages whose content may consist of text, pictures, sound and video). It may be deployed on a mobile network (for example a GSM, GPRS or UMTS network) or on a fixed landline or other network (with information sent in-band).

The multimedia messaging service is provided by an MMS centre which stores MMS messages and forwards them to their recipients.

To be able to use this service from a mobile telephone, the user's mobile telephone must have an MMS client, which is an application integrated into the terminal for composing, presenting, sending, and receiving MMS messages. Likewise, using this service from a fixed telephone necessitates an appropriate telephone.

Messages received by a user are typically stored in the user's terminal.

The embodiment described here (FIG. 1) enables a user to send a voice message, that is to say an efficaciously personalized audio message, from the user's own terminal to the voice mailbox of one or more other users without having to connect before preparing the message.

To provide this service, the MMS infrastructure sends the audio message from the user's terminal, preferably to a short-code number defined by the operator providing the service.

The telephone number(s) of the recipient(s) or the circulation list(s), where applicable, are indicated by the user either in the subject field of the MMS message or in a text element of the MMS message itself (for example using the “;” character as a separator between the various recipients).

The following are examples of text elements of an MMS message sent in this way:

“0600000000”: in this case, the voice dispatch is deposited in the voice mailbox for the number 06 00 00 00 00,

“0600000000; 0600000001; List 1; 0600000002; List 2”: in this case, the voice dispatch is deposited in the voice mailboxes of the numbers 06 00 00 00 00, 06 00 00 00 01 and 06 00 00 00 02, and in the voice mailboxes of all the numbers in the predefined circulation lists 1 and 2 held in the sender's voicemail system.

When the voicemail system receives the above MMS message, the audio element it contains is deposited in the voice mailbox(es) of the recipient(s) specified in the subject field or the text element of the MMS message.

At the functional level, and in a situation where the user 10 sends the voice dispatch to three users, the further operations executed are as follows:

Firstly, the (fixed or mobile) user 10 creates a voice dispatch (audio element) on the user's own terminal. The user 10 then composes on the terminal an MMS message 15 consisting of an audio element 17, i.e. the voice dispatch, and a text element 19 including a list of the telephone numbers of the recipients 34, 36, and 38.

The user 10 then sends the MMS message 15 to a short-code number N corresponding to an MMS centre 20. The MMS centre 20 then sends the message 15 to the voicemail system 30.

In an alternative system, two short-code numbers N1 and N2 are respectively dedicated to receiving and processing a message for a voice mailbox and a voicemail greeting. The user sends an MMS message to the number N1 or the number N2, depending on the nature of the audio content.

Finally, a processing unit 32 in the voicemail system recovers the audio element 17 and the telephone numbers contained in the MMS message 15 received and then deposits the voice message 17 in the voice mailboxes 34, 36 and 38.

Mobiles (in particular MMS mobiles) today offer increasingly rich options for composing audio messages that are generally much richer and more flexible than those available on current servers offering services for sending voice dispatches.

Those options include recording the voice of the user or any kind of sound, composing a piece of music, using audio elements available in the terminal (default elements in the terminal, elements received via MMS messages, elements downloaded via an infrared link, etc.).

Although the content 17 is defined above as being a voice content, in the context of the invention the content 17 of the message 15 could be made up of electronically generated sounds with no voice content. Moreover, any voice content could be prerecorded, where appropriate a prerecorded synthesized voice.

Modern terminals also provide for mixing different audio elements, adding effects (echo, distortion, fades, etc.), background sounds, signature sounds, etc.

Between composing and sending them, the sound messages are stored in the memory of the mobile terminal, for example.

Thus the above functions are used in the context of making this kind of message available via a remote messaging system, here of the type consulted by setting up a telephone call, whereupon users hear their own voicemail messages or the voicemail greeting of the called parties. The system may also be consulted via the WorldWide Web using a computer.

Depending on the voicemail system used by the operator and the architecture employed, a Simple Mail Transfer Protocol (SMTP) or Simple Object Access Protocol (SOAP) interface may provide adequate connections.

The MMS centre 20 may use MM3 or MM7 interfaces, depending on the architecture adopted. The interface between the MMS centre 20 and external messaging systems is the MM3 interface. It is not standardized but implementation examples (using SMTP) are given in the appendices of the MMS standard (see reference [3]).

The interface between the MMS centre 20 and added value service providers is the MM7 interface, which is standardized (see reference [4]).

The connection of the MMS centre 20 and the voicemail system 30 uses the MM3 interface to the MMS centre (which is based on the SMTP) and an SMTP interface to the voicemail system, for example.

To this end, the user 10 sends the MMS message to the short-code number N (or one of the numbers N1, N2) via the interface MM1 to the MMS centre, which sends the message to the voicemail system via its MM3 (SMTP) interface.

Another embodiment uses an MM7 interface (which is based on the SOAP) to the MMS centre 20 and a SOAP interface to the voicemail system.

To this end, the user 10 sends the MMS message to the short-code number N via the interface MM1 of the MMS centre, which sends the message to the voicemail system via its MM7 (SOAP) interface.

In a second embodiment described below, for personalizing a voicemail greeting, it is proposed that the user send a specific audio message from the user's terminal to the voicemail system.

When the voicemail system receives the message, it modifies the voicemail greeting of the sender's voice mailbox (substituting the audio element contained in the received MMS message for the old voicemail greeting).

To provide this service the MMS infrastructure sends the audio message from the user's terminal, preferably to a short-code number defined by the operator providing the service.

FIG. 2 shows the operations enabling the user 10 to modify a voicemail greeting.

Firstly, the (fixed or mobile) user 10 creates a voicemail greeting (audio element) on the terminal. The user 10 then composes on the terminal an MMS message 15 containing that audio element 17. The user 10 then sends that MMS message to the short-code number N (or to one of the numbers N1, N2) of an MMS centre 20, which then sends the message to the voicemail system 30.

Finally, a processing unit 32 in the voicemail system recovers the audio element 17 contained in the MMS message 15 and the telephone number of the sender of the message and replaces the sender's voicemail greeting 39 with the audio element in the voice mailbox 38.

Depending on the voicemail system used by the operator and the architecture employed, a Simple Mail Transfer Protocol (SMTP) or Simple Object Access Protocol (SOAP) interface may be used to implement the present invention.

The MMS centre may use the MM3 or MM7 interface, depending on the architecture employed.

The connection of the MMS centre and the voicemail system 30 is provided by the MM3 interface to the MMS Centre (which is based on the SMTP) and an SMTP interface to the voicemail system, for example.

For this purpose, the user 10 sends an MMS message to the short-code number N via the existing interface MM1 of the MMS centre, which sends the message to the voicemail system via its MM3 (SMTP) interface.

Another embodiment uses an MM7 interface to the MMS centre 20 based on the SOAP protocol and a SOAP interface to the voicemail system.

For this purpose, the user 10 sends an MMS message to the short-code number N via the interface MM1 of the MMS centre, which then sends the message to the voicemail system 30 via its MM7 (SOAP) interface (this is a novel feature of the invention).

The service provided by the present invention is advantageous for a mobile or fixed telecommunications operator in particular.

[1] 3GPP TS 22.140

High-level Service Requirements

Release 5

[2] 3GPP TS 23.140

MMS Architecture, Information Flow, Functional Behavior

MM7—Transactions, Protocol Bindings and Formats

Release 5

[3] 3GPP TS 23.140 (Appendix A): “Appendix A (for information only): Examples of MMS architectural implementations”

[4] W3C Note of 8 May 2000: “Simple Object Access Protocol (SOAP) 1.1”

1. A method of making a sound content available, the method comprising a step of producing a sound content and sending it by means of a telephone terminal (10) and a step of receiving (20) and storing (32) said sound content with a view to subsequent consultation by a telephone terminal, the method being characterized in that it comprises a step of the telephone terminal (10) producing the sound content that precedes and is temporally separate from said step of the telephone terminal sending said sound content.

2. A method according to claim 1, characterized in that the step of producing the sound content includes the production of a voice content included in the sound content.

3. A method according to claim 1 or claim 2,
characterized in that the step of storage in memory in a form adapted to be consulted consists in depositing the message in a telephone user's voice mailbox (34, 36, 38) as a message for that user.

4. A method according to claim 1 or claim 2,
characterized in that the step of storage in memory in a form adapted to be consulted consists in recording the message in an entity (39) for sending a voicemail greeting for a voice mailbox (38) as the voicemail greeting (39) of that voice mailbox (38).

5. A method according to any one of claims 1 to 4, characterized in that the step of producing the sound content consists in composing an MMS message (15) including the sound content (17).

6. A method according to claim 5, characterized in that the MMS message contains an element consisting of the sound content (17) and an element (19) consisting of the coordinates of at least one recipient of the sound content (34, 36, 38).

7. A method according to claim 6, characterized in that the coordinates of the recipient (34, 36, 38) of the sound content are telephone coordinates.

8. A method according to claim 6 or claim 7,
characterized in that the element (19) consisting in the coordinates of the recipient(s) contains the coordinates of a plurality of recipients.

9. A method according to any one of claims 6 to 8, characterized in that it comprises the step of storing the sound content (17) in a series of voice mailboxes (34, 36, 38) of different recipients as indicated in said element (19) consisting of coordinates of the recipients (34, 36, 38).

10. A method according to any preceding claim,
characterized in that the step of producing the sound content (17) comprises the step of modifying a voice recording (17) using sound processing functions provided by the telephone terminal (10).

11. A method according to the preceding claim,
characterized in that the step of producing the sound content (17) consists in producing a voice recording in a memory of the telephone terminal (10) and superimposing on that voice recording at least one sound content prestored in the memory of the telephone terminal (10).

12. A telecommunications device for making available a sound content (17) addressed to at least one telephone terminal holder, the device comprising a sound content receiver entity (20, 32) and a sound content storage entity (34, 36, 38) that may be consulted by telephone, the device being characterized in that the receiving entity (20, 32) and the storage entity (34, 36, 38) are adapted to read a message (15) precomposed on a telephone terminal before it is sent thereby and to store a sound content included in that message in memory in a form that may be consulted.

13. A device according to claim 12, characterized in that the storage entity (34, 36, 38) is a telephone user's voice mailbox (34, 36, 38).

14. A device according to claim 12, characterized in that the storage entity (34, 36, 38) is an entity (39) for sending a voicemail greeting for use by a voice mailbox (38) of a telephone user (10).

15. A device according to any one of claims 12 to 14, characterized in that the message receiver entity (20, 32) and the storage entity (34, 36, 39) for storage in a form that may be consulted are adapted to read an MMS message (15) and to store a sound content (17) included in that MMS message (15) in a form that may be consulted by telephone.

16. A device according to claim 15, characterized in that the message receiver entity (20, 32) comprises means for reading an MMS message (15), identifying and extracting coordinates of recipient(s) included in said message, and sending the sound content (17) of the MMS message (15) to one or more storage entities (34, 36, 38) corresponding to those recipient coordinates (19).
